(19) United States
(12) Patent Application Publication
(10) Pub. No.: US 2007/0059215 A1
(43) Pub. Date: Mar. 15, 2007

(54) Micro pipette sensing device

(75) Inventor: Pony Huang, Taipei Hsien (TW)

Correspondence Address: HDSL, 4331 STEVENS BATTLE LANE, FAIRFAX, VA, 22033, US

(73) Assignee: Pacific Image Electronics Co., Ltd.

(21) Appl. No.: 11/225,079

(22) Filed: Sep. 14, 2005

(51) Int. Cl. B01L 3/02

(52) U.S. Cl. 422/100

(57) ABSTRACT

A micro pipette sensing device includes a micro pipette and a sensing device. The micro pipette includes a main portion, an operation portion and at least one tube portion. The tube portion defines an operation space therein. The sensing device is located at a proper position in the operation space of the tube portion. The sensing device includes a MEMS flow sensor for sensing a gas movement in the operation space, thereby effectively improving the precision of solution to be taken and therefore improving the precision of the overall measurement and analysis results.

### BACKGROUND OF THE INVENTION

1. Field of the Invention

The present invention relates to micro pipettes, and more particularly to a micro pipette sensing device which can sense a flow variation and feed back the flow variation information to amend it so as to obtain a more precise volume of solution to be transferred.

2. Description of Related Arts

Micro pipettes are usually used in various medical and biochemical experiments, tests or analysis to take and transfer solution samples. During these medical and biochemical experiments, tests or analysis, particularly in very precise and complicated experiments such as DNA tests and analysis, the volume of the solution samples taken and transferred by the micro pipettes must be extremely precise. Imprecision of the volume of the solution sample in one single step will often cause a considerable error of the final results, or badly affect the correctness of the test and analysis results.

The conventional micro pipettes are generally classified into two categories in terms of its operation manner, i.e., manual pipettes and electronically automatic pipettes. In terms of its sample taking manner, the micro pipettes are often categorized by multiple-tube pipettes and single-tube pipettes. One typical multiple-tube pipette 91 is illustrated in FIG. 1, and one typical single-tube pipette 92 is illustrated in FIG. 2. Though the conventional micro pipettes are able to take and transfer the solution sample, they have deficiencies in precisely controlling the volume of the solution sample. FIG. 3 illustrates a micro pipette 93 comprising a tube 94 and a pipette tip 95 attached around a bottom of the tube 94. The pipette tip 95 defines a through opening 951 in a bottom thereof. A piston member 96 is disposed within the tube 94. Moving the piston member 96 in the tube 94 can suck the solution into the pipette tip 95. However, one pipette tip 95 corresponds to solutions of a predetermined and fixed volume. Therefore, the pipette tip 95 often needs to be replaced for transferring solutions of different volumes (for example, 20 mL˜200 mL). Repeated attachment or detachment of the pipette tip 95 to or from the tube 94 cause abrasions on the tube 94 and the pipette tip 95, thereby forming a clearance between the pipette tip 95 and the tube 94. The tube 94 and the pipette tip 95 thus can not be closely interconnected. This will bring a sealing problem which will eventually cause a variation of the solution volume transferred by the micro pipette 93, often referred to as “pipette error”. This pipette error will affect the correctness of the medical or biochemical experiments or tests, or mislead an analysis results. Therefore, researches and developments in the industry are directed to how to improve the precision of controlling the solution volume took and transferred by the micro pipette. What is needed, therefore, is to provide a micro pipette which can address the above deficiencies and inadequacies.

### SUMMARY OF THE INVENTION

An object of the present invention is to provide a micro pipette sensing device, which can improve the precision of solution to be taken and transferred and therefore improve the precision of the overall measurement and analysis results.

A further object of the present invention is to provide a micro pipette sensing device which can sense the status information of taking solution and feed back the information to thereby effectively control the precision of taking solution.

To achieve the objects as set forth above, the micro pipette sensing device includes a micro pipette and a sensing device. The micro pipette includes a main portion, an operation portion and at least one tube portion. The tube portion defines an operation space therein. The sensing device is located at a proper position in the operation space of the tube portion. The sensing device includes a MEMS flow sensor for sensing a gas movement in the operation space.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

FIG. 1 is a schematic view of a conventional multiple-tube pipette;

FIG. 2 is a schematic view of a conventional single-tube pipette;

FIG. 3 is a cross-sectional view a tube of the conventional single-tube pipette of FIG. 2;

FIG. 4 is a schematic view of a micro pipette in accordance with a preferred embodiment of the present invention;

FIG. 5 is a cross section of a tube portion of the micro pipette of FIG. 4, showing a piston in a lifted state;

FIG. 6 is a cross section of a tube portion of a micro pipette according to an alternative embodiment of the present invention, showing the piston in a fall state;

FIG. 7 is a cross section of the tube portion of FIG. 6; and

FIG. 8 is a cross section of a tube portion of a micro pipette according to a further embodiment of the present invention.

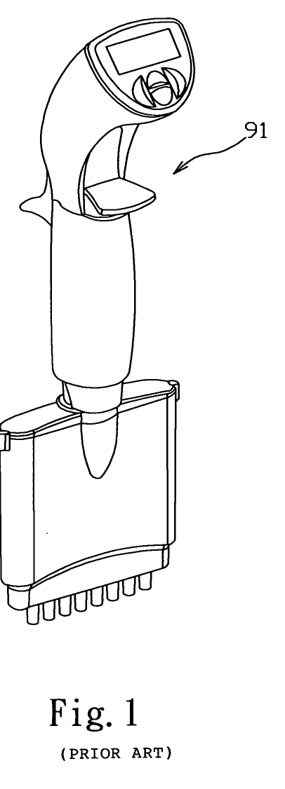

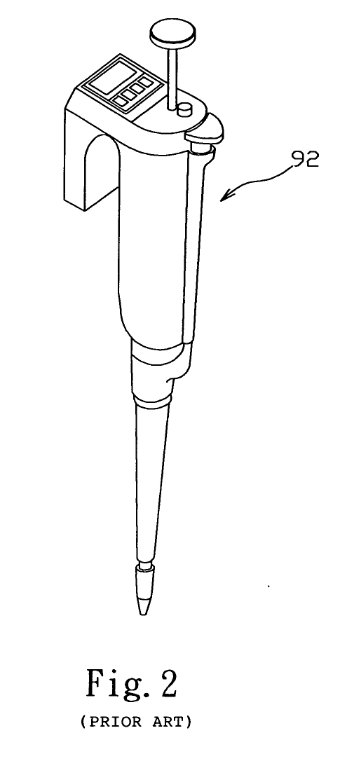

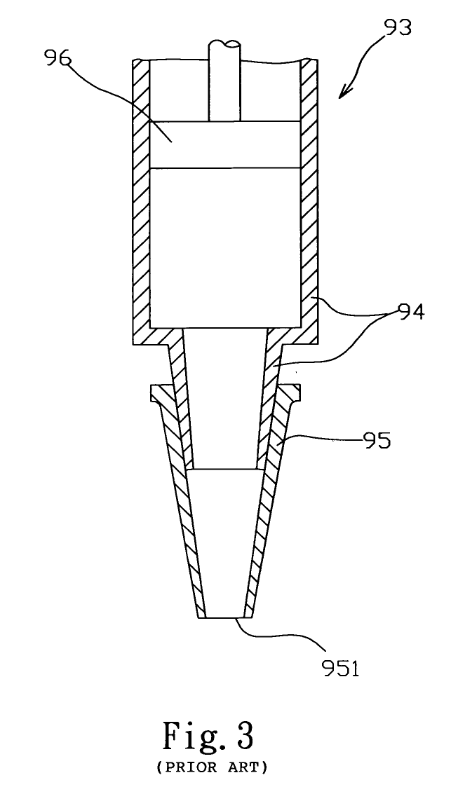

### DESCRIPTION OF PREFERRED EMBODIMENTS

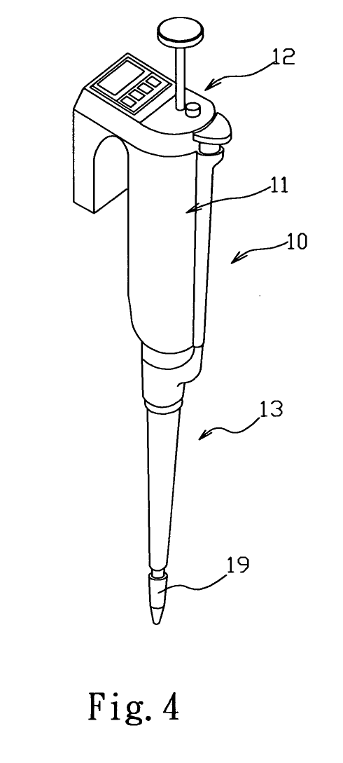

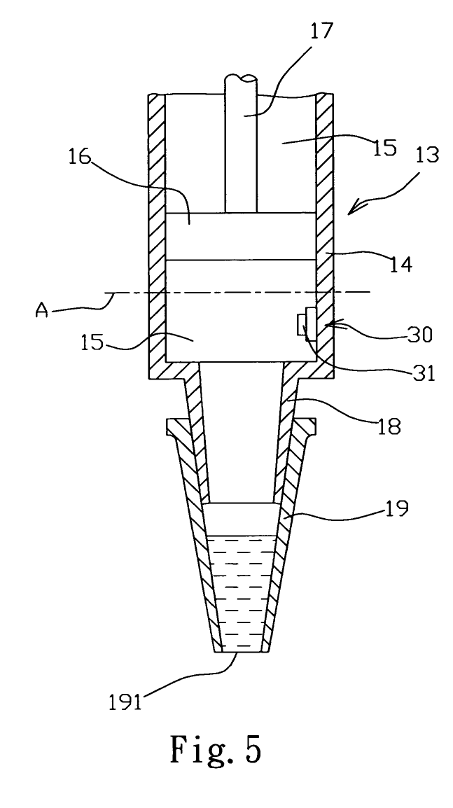

Referring to FIGS. 4 and 5, a micro pipette sensing device comprises a micro pipette 10 and a sensing device 30. The micro pipette 10 comprises a main portion 11, an operation portion 12 and a tube portion 13. The operation portion 12 may be an electronically automatic operation type or a manual operation type. The tube portion 13 may be a single-tube type or a multiple-tube type. In case of a multiple-tube type, the tube portion 13 comprises a plurality of tubes. This embodiment takes a single-tube type for example. The tube portion 13 comprises a tube wall 14. The tube wall 14 defines an operation space therein. A piston member 16 is disposed in the operation space 15. The piston member 16 connects to a piston rod 17. The piston rod 17 is driven by a step motor (not shown) to move. In this preferred embodiment, the operation space sets a top head center and a bottom head center cooperatively defining a piston stroke of the piston member 16. The tube portion 13 at a bottom thereof forms a connecting portion 18 having a reduced diameter. The connecting portion 18 is a taper tube, a diameter of which gradually decreases along a downward direction. A pipette tip 19 is attached around the connecting portion 18. The pipette tip 19 is a taper tube with a through opening 191 defined in a bottom thereof.

The sensing device 30 is disposed at a proper position in the operation space 15. The sensing device 30 comprises a MEMS flow sensor 31 attached on the tube wall 14 of the tube portion 13 and located in the operation space 15. In the preferred embodiment, the flow sensor 31 comprises a flow sensor IC integrated with a CMOS amplifying circuit. The microstructure of the flow sensor IC comprises a deep-etched silicon cavity. Polysilicon is deposited in the silicon cavity to form a cross bar. A plurality of Si/Al thermopiles is arranged around the cross bar. The flow sensor 31 can sense a gas movement caused by a gas field being pressed. The flow sensor 31 is able to obtain a precision level of nano-liter per second under a standard atmospheric pressure. The flow sensor 31 can record the sensed pipette error and cooperates with a commercially available Time PCR Machine to conduct experiments such as quantitative analysis of DNA, thereby improving the reliability of DNA quantitative experiment

The above-described sensing device 30 is located in the operation space 15, so as to sense a gas displacement and gas flow variation as the piston member 16 is moved. In alternative embodiments, the sensing device 30 may be joined with the piston member 16, or located below the piston member 16.

Referring to FIG. 5, the sensing device 30 is located in the operation space, below the bottom head center, designated as letter A, of the piston member 16 (or at other position, i.e., above the top head center of the piston member 16). As the piston member 16 moves upwardly during operation of the pipette 10, the sensing device 30 can sense correct gas flow, gas displacement, or gas flow variation information caused by a sealing problem or mechanical operation clearance, and transmit such information to related information receiving apparatus (not shown), thereby precisely controlling the solution volume to be taken. When the solution volume is not correct, the information receiving apparatus amends the information in a manner of feeding back the information to the micro pipette 10 to obtain a correct solution volume.

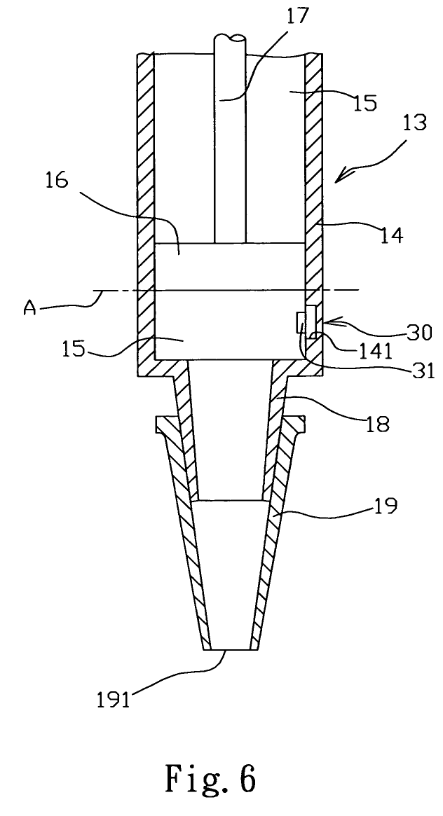

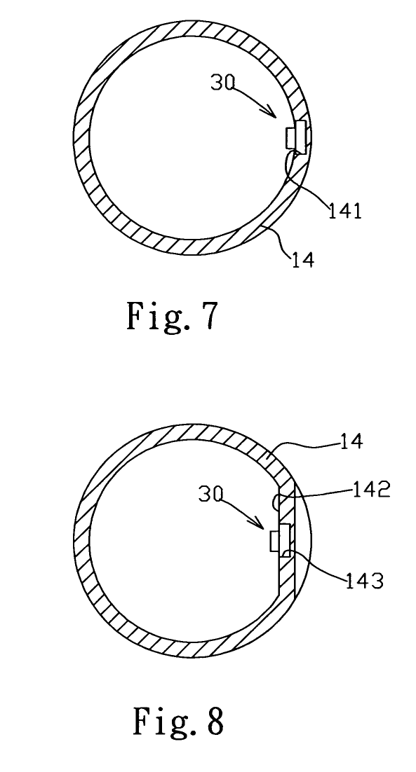

Referring to FIGS. 6 and 7, the tube wall 14 of the tube portion 13 further defines a nesting recess 141, for allowing the sensing device 30 to be nested therein to achieve an improved sensing result.

Referring to FIG. 8, the tube wall 14 of the tube portion 13 may form a flat surface 142, for attachment of the sensing device 30. A nesting recess 143 may preferably formed at the flat surface 142, for allowing the sensing device 30 to be nested therein.

In embodiments of the present invention, the sensing device 30, disposed at a proper position of the tube wall 14 of the tube portion 13, can sense the correct gas displacement information, or gas flow variation information caused by sealing problem or mechanical operation clearance. By processing this information, a correct solution volume can be detected. Therefore, the present invention can effectively control the precision of the volume of the solution to be taken and transferred.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

We claim:

1. A micro pipette sensing device comprising:
a micro pipette comprising a main portion, an operation portion and at least one tube portion, the tube portion defining an operation space; and
a sensing device located at a predetermined position in the operation space of the tube portion, the sensing device comprising a MEMS flow sensor for sensing a gas movement in the operation space.

2. The micro pipette sensing device of claim 1, wherein a piston member is received in the operation space of the tube portion, and a piston rob connects to the piston member to drive the piston member to move.

3. The micro pipette sensing device of claim 1, wherein the tube portion forms a connecting portion at a bottom thereof, and a pipette tip is attached around the connecting portion.

4. The micro pipette sensing device of claim 1, wherein the tube portion comprises a tube wall for attachment of the sensing device.

5. The micro pipette sensing device of claim 4, wherein the tube wall further defines a nesting recess for allowing the sensing device to be nested therein.

6. The micro pipette sensing device of claim 4, wherein the tube wall has a flat surface for attachment of the sensing device.

7. The micro pipette sensing device of claim 6, wherein the tube wall defines a nesting recess at the flat surface thereof for allowing the sensing device to be nested therein.

8. The micro pipette sensing device of claim 1, wherein the operation space sets a top head center and a bottom head center of the piston member, and the sensing device is located at one of a first position above the top head center and a second position below the bottom head center.

9. The micro pipette sensing device of claim 1, wherein the MEMS flow sensor comprises a flow sensor integrated circuit (IC) integrated with a complementary metal oxide semiconductor (CMOS) amplifying circuit, and the microstructure of the flow sensor IC comprises a deep-etched silicon cavity, polysilicon deposited in the silicon cavity to form a cross bar, and a plurality of Si/Al thermopiles arranged around the cross bar.

10. The micro pipette sensing device of claim 1, wherein the sensing device is joined with the piston member.

11. The micro pipette sensing device of claim 1, wherein the sensing device is located below the piston member.
